(19) United States
(12) Patent Application Publication
(10) Pub. No.: US 2016/0339850 A1
(43) Pub. Date: Nov. 24, 2016

(54) ARTICULATING HITCH LIFT SYSTEM

(71) Applicant: Jon A. Williams, JR., Spring, TX (US)

(72) Inventor: Jon A. Williams, JR., Spring, TX (US)

(21) Appl. No.: 14/720,731

(22) Filed: May 22, 2015

(51) Int. Cl. B60R 9/06

(52) U.S. Cl. CPC B60R 9/06

(57) ABSTRACT

The present application includes a system and method of loading and transporting objects in remote areas. The system includes a hitch mount to engage a receiver on a vehicle. A lift arm is pivotally coupled to the hitch mount and is configured to operate between a first position and a second position through the use of a lifting member. The lifting member is optionally motorized and may receive energy through a connector in communication with the vehicle or receive energy through a battery associated with the lifting member. By articulating the lift arm, the attachment member is lowered to ground level to permit loading without needing to lift the object and raised for safe transportation. The weight of the system and any contents are carried by the vehicle directly through the receiver.

### BACKGROUND

1. Field of the Invention

The present application relates generally to accessories for all-terrain vehicles and, more particularly, to a hitch based articulating lift system for use behind a vehicle to lift objects.

2. Description of Related Art

The transportation and loading of heavy or large objects within remote areas can be difficult. Examples of objects include natural materials, such as wood, dirt, rocks, and water. Other examples may include wildlife, such as the recent kill of a hunter. Vehicles are commonly used in remote areas for transporting objects. The vehicles may be all-terrain vehicles, recreational vehicles or personal/commercial automobiles for example.

A disadvantage of conventional methods is that they typically require an individual to lift the object manually. The object may be placed on a suitable spot on the vehicle itself and secured. In other methods, an individual may try and use a trailer to carry the object in an effort to lower the lifting height of the object. However trailers have their disadvantages as well. With respect to trailers, trailers tend to be noisy from the motion between it and the vehicle. Trailers can make a vehicle less maneuverable and tend to slow a vehicle down. Another disadvantage of trailers is the need to lift the object into the trailer.

The rugged terrain often experienced in remote areas tends to limit the individual in terms of tools used to carry heavy and large loads. It is desirable to provide a tool that can be attached to a vehicle that allows an individual to carry large and heavy loads without the need to lift the load manually or pull behind the vehicle thereby limiting the off road capabilities of the vehicle itself.

Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of an articulating hitch lift system according to the preferred embodiment of the present application, the system being in a first orientation; and

FIG. 2 is a side view of the articulating hitch lift system of FIG. 1 being in a second orientation;

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system in accordance with the present application overcomes one or more of the above-discussed problems commonly associated with conventional transportation methods and devices. Specifically, the system of the present application is configured to provide a simplified and easier method of loading and unloading heavy contents without the need to manually elevate the content off the ground. Additionally the system is configured to permit the transportation of the contents behind a vehicle without the need of a trailer or other contact to the ground. In particular the system of the present application is configured to couple to the existing receiver of a vehicle and articulate an attachment member between two orientations that allow for simplified loading and easy transportation. These and other unique features of the system are discussed below and illustrated in the accompanying drawings.

The system will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

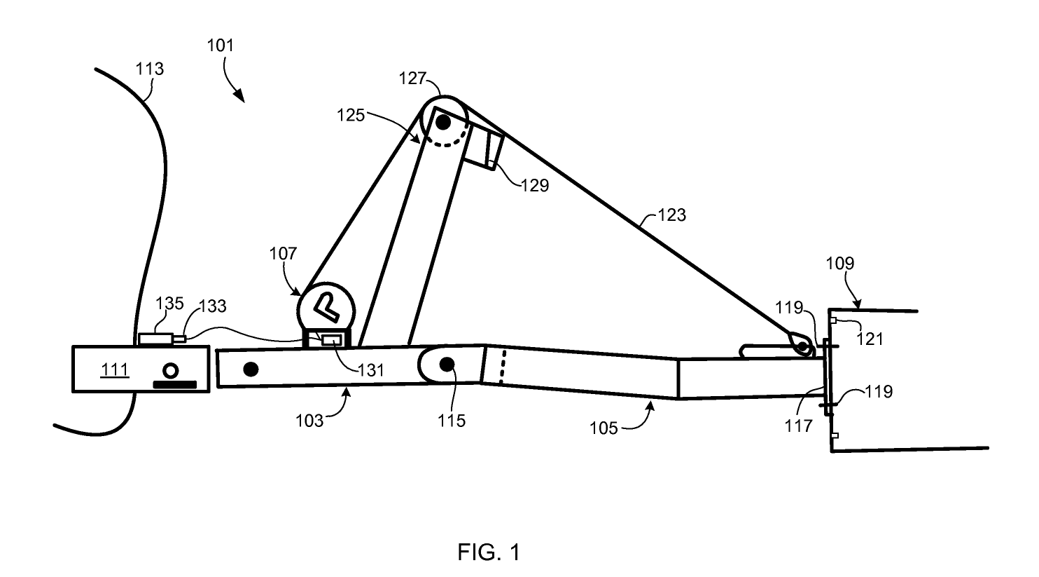

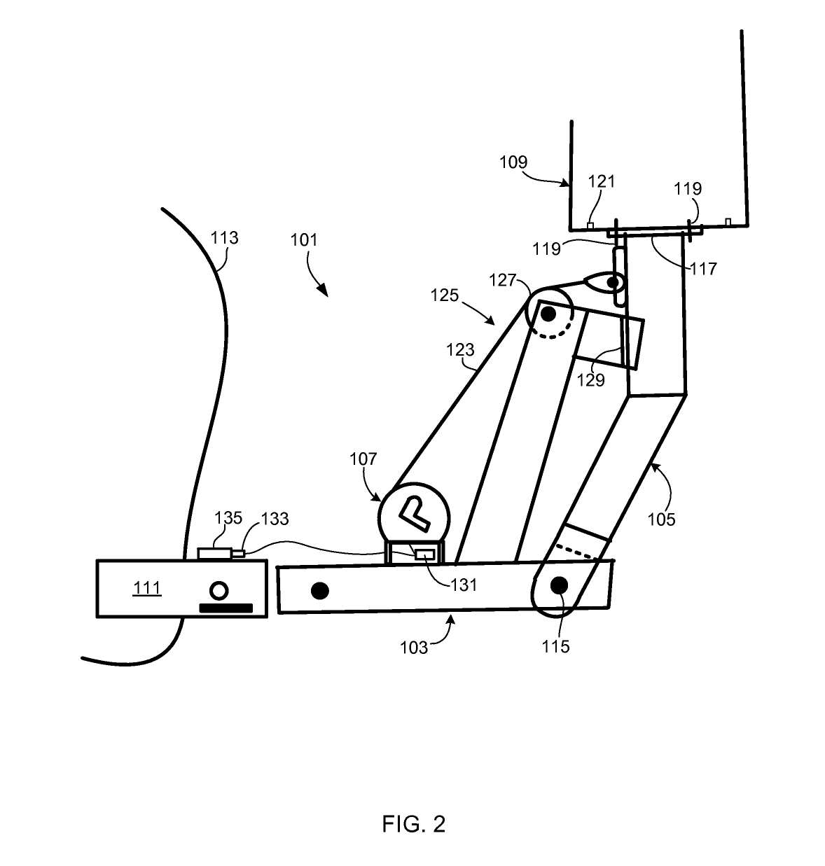

The articulating hitch lift system of the present application is illustrated in the associated drawings. Referring now to the drawings wherein like reference characters identify corresponding or similar elements in form and function throughout the several views. FIGS. 1-2 in the drawings illustrate an articulating hitch lift system 101. System 101 includes a hitch mount 103, a lift arm 105, a lifting member 107, and an attachment member 109. System 109 is configured to operate attachment member 109 between two orientations/positions, namely and elevated or up position and a lowered or down position. System 101 is configured to place attachment member 109 in the lowered position to allow for the loading of an object without the need to lift it off the ground. Additionally, system 101 is configured to raise attachment member 109 and its contents to the elevated position during transportation. The contents within attachment member 109 are carried by the vehicle through the receiver of the vehicle.

A more detailed description of system 101 follows. Hitch mount 103 is configured to releasably couple to a receiver 111 of a vehicle 113. Hitch mount 103 is coupled to receiver 111 as conventional or traditional ball and hitches would. Mount 103 is slid within receiver 111. A pin is inserted through a matching hole between receiver 111 and hitch mount 103 to secure them together. The weight of system 101 and any contents within attachment member 109 are carried by the vehicle off the ground through receiver 111. By using traditional receivers 111 to attach system 101, system 101 is adapted for use on a plurality of vehicle types without the need for modification to vehicle 113. When not in use, system 101 may be removed and stored away.

Lift arm 105 is pivotally coupled to hitch mount 103 at an end opposite that of receiver 111. In particular, lift arm pivots about pivot point 115. A pin is used to permit the pivoting of lift arm 105 relative to that of hitch mount 103. Lift arm is configured to transition between a first orientation/position (lowered) and a second orientation/position (raised). At the opposite end of lift arm 105 from pivot point 115 is attachment member 109. When in the lowered position, attachment member 109 is adjacent ground level thereby permitting the loading and unloading of member 109 without the need to lift the objects off the ground. Objects may be dragged, rolled, or pushed into attachment member 109. When in the second position (raised) attachment member 109 is configured to transport objects off the ground behind vehicle 113.

Attachment member 109 is releasably coupled to lift arm 105 and is configured to selectively secure one or more contents/objects for transportation by vehicle 113. As illustrated in the figures, attachment member 109 may be that of a bucket having two parallel surfaces separated by a joining portion. However, it is understood that attachment member 109 is not so limited to the precise embodiment shown. Member 109 may take multiple forms to help serve multiple services. Embodiments of member 109 may include optional sides to help create a defined interior volume. Additionally, member 109 may include an optional lid to form an enclosed space. Furthermore, member 109 may be a scoop, a blade, or a scraper. Other shapes are contemplated.

A mounting plate 117 is coupled to lift arm 105 and is used to contact a portion of member 109. Fasteners 119 are used to couple member 109 to lift arm 105. By loosening fasteners 119, member 109 may be interchanged. Another feature of attachment member 109 is the ability to secure contents or objects to itself. Member 109 optionally includes one or more attachment locations 121 configured to permit an individual to tie down the contents to prevent shifting during transportation. Examples of attachment locations 121 could be apertures or a loop sized to permit the latching of a hook. System 101 may include one or more straps to engage attachment location 121. The securing of contents may be performed with member 109 at any position between the first position and the second position.

Lifting member 107 is configured to articulate lift arm 105 between the first position and the second position. Lifting member 107 is in communication with hitch member 103 and lift arm 107. Suitable methods of communicating lifting member 107 to that of lift arm 105 in order to articulate attachment member 109 is to use cables, such as cable 123, or through gearing. Gearing is understood to be more complex and heavier and is not considered as viable. As seen in the figures, lifting member 107 is coupled to hitch member 103 and includes cable 123 extending from itself to a surface of lift arm 105. By operating lifting member 107, cable 123 is wound our unwound to articulate member 109.

In order to leverage the forces placed upon lift arm 105 via cable 123, a lift arm stop 125 is used. Lift arm stop 125 is coupled to hitch mount 103 and extends above lifting member 107. A pulley 127 is used to modify the route of cable 123. In order to prevent the over rotation of attachment member 109, lift arm stop 125 includes a stop 129 which acts to contact a portion of lift arm 105. Lifting member 107 maintains a tension on cable 123 so as to pull lift arm 105 into contact with stop 129. During transportation, this tension is sufficient to secure attachment member 109 in the second position. However, system 101 may also be configured to include one or more clips or storing devices that mechanically secures lift arm 105 in the second position without the need of lifting member 107.

Examples of lifting members 107 can be that of a hand crank. As a hand crank, an individual would manually (hand operate) articulate member 109. Another embodiment of lifting member 107 is that of a motor. As a motor, for example a winch, lifting member 107 uses electrical energy to operate. Electrical energy may be provided by using a battery or by pulling power directly from vehicle 113. Lifting member 107 may include a battery 131 to provide power. Battery 131 may be rechargeable. Furthermore, lifting member 107 may optionally include one or more connectors 133 configured to couple to a rear electrical plug 135 associated with receiver 111. Plug 135 may commonly be used lights on trailers in conventional towing applications. Where battery 131 and connectors 133 are used together, battery 131 may be charged or maintained at a full charge from the electrical system of vehicle 113.

The current application has many advantages over the prior art including at least the following: (1) articulation of an object off the ground for transportation; (2) weight of the object being carried by a vehicle through the receiver; (3) simple removal from the vehicle for storage; (4) ability to lower the loading height of the attachment member to ground level to avoid the need to lift the objects into the attachment member; (5) interchangeability of the attachment member; and (7) power source optionally provided from the vehicle or an alternative battery associated with the system.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An articulating hitch lift system, comprising:
a hitch mount configured to releasably couple to a receiver, the receiver being mounted to a vehicle;
a lift arm pivotally coupled to the hitch and configured to transition between a first orientation and a second orientation;
a lifting member in communication with the hitch member and the lift arm; the lifting member configured to articulate the lift arm between the first orientation and the second orientation; and
an attachment member coupled to the lift arm and configured to selectively secure one or more contents for transportation by the vehicle.

2. The system of claim 1, wherein the lifting member is coupled to the hitch member.

3. The system of claim 1, wherein the lifting member is a winch.

4. The system of claim 1, wherein the lifting member is powered by electrical energy.

5. The system of claim 4, wherein the electrical energy is provided through a battery.

6. The system of claim 4, wherein the lifting member is powered by pulling electrical energy from the vehicle.

7. The system of claim 1, wherein the lifting member is a hand operated crank.

8. The system of claim 1, wherein the lifting member is coupled to the lift arm through a cable.

9. The system of claim 1, wherein the attachment member is removable.

10. The system of claim 1, wherein the attachment member is at least one of a box, scraper, scoop, bucket, and blade.

11. The system of claim 1, wherein the lift arm is configured to be lowered into the first orientation to load and unload the contents in the attachment member.

12. The system of claim 1, wherein the lift arm is configured to be raised into the second orientation for transportation.

13. The system of claim 1, wherein the attachment member is configured to transport objects behind the vehicle off the ground.

14. The system of claim 1, wherein the attachment member includes one or more attachment locations to permit the contents within the attachment member to be secured during transportation.

15. The system of claim 14, wherein the contents of the attachment member are tied down and secured prior transportation.

16. The system of claim 1, wherein the weight of the contents within the attachment member are carried by the vehicle through the receiver.

17. The system of claim 1, further comprising:
a stop configured to prevent the over rotation of the lift arm toward the vehicle.
